(19) United States
(12) Patent Application Publication
(10) Pub. No.: US 2023/0013273 A1
(43) Pub. Date: Jan. 19, 2023

(54) MODULE HOUSING ASSEMBLY, BATTERY MODULE, AND METHOD FOR CLAMPING A BATTERY MODULE

(71) Applicant: AUDI AG, Ingolstadt (DE)

(72) Inventors: Martin SCHUESSLER, Koesching (DE); Markus THURMEIER, Adlkofen (DE); Florian DIRISAMER, St. Georgen/Grieskirchen (AT)

(73) Assignee: AUDI AG, Ingolstadt (DE)

(21) Appl. No.: 17/858,273

(22) Filed: Jul. 6, 2022

(30) Foreign Application Priority Data
Jul. 15, 2021 (DE) 102021118396.0

(51) Int. Cl. H01M 50/264; H01M 50/204

(52) U.S. Cl. CPC H01M 50/264; H01M 50/204

(57) ABSTRACT

A module housing assembly for accommodating at least one battery cell, including a module housing with a housing base, which delimits a receiving area for accommodating the at least one battery cell with respect to a first direction, and two side plates, which delimit the receiving area on both sides with respect to a second direction. The module housing assembly additionally including a retaining element for arrangement on the at least one battery cell accommodated in the receiving area, and a clamping device, which extends at least from a first of the side plates to a second of the side plates on a side of the receiving area opposite the housing base, wherein the clamping device is designed in such a way that the clamping device can exert a force on the retaining element in the direction of the housing base, if said retaining element is arranged on the at least one battery cell arranged in the receiving area.

### FIELD

The disclosure relates to a module housing assembly for accommodating at least one battery cell, wherein the module housing assembly has a module housing with a housing base, which delimits a receiving area for accommodating the at least one battery cell in a first direction, and two side plates, which delimit the receiving area on both sides in a second direction. Furthermore, the disclosure also relates to a battery module with such a module housing assembly and a method for clamping a battery module.

### BACKGROUND

Current battery modules or the housings thereof are made from a plurality of components and connected to one another. Such a module housing often has two side plates, which are also referred to as end plates, and which delimit a cell stack in the longitudinal extension direction thereof with several battery cells arranged next to one another in a longitudinal extension direction. These end plates are usually clamped together by a clamping mechanism, for example with so-called side binders, i.e. side parts that extend on both sides of the cell stack in the longitudinal extension direction thereof and connect the end plates to one another under tension. These side binders usually have a chamfer on the upper edge so that the cells do not fall out of the module when subjected to loads in the z-direction. The z-direction usually defines a direction from a module lower side to the module upper side, wherein the terminals of the battery cells typically are arranged on the upper sides thereof if there is a cooling device on the module lower side. The housing base of such a battery module is often provided by an overall battery base for all battery modules accommodated in a high-voltage battery and not separately for each battery module. In other words, a module housing, as it is typically designed, can merely be understood as a bottomless frame. The battery modules can then be used in an overall battery housing with a cooling base. For the thermal connection to the cooling base, a so-called gap filler is usually introduced between the module lower sides and the cooling base, which gap filler can be provided, for example, as a heat-conducting compound or heat-conducting paste.

This large number of parts has clear disadvantages in terms of preloading the cells, since the forces often cannot be optimally dissipated and the structures are not as stiff as would be ideal. In addition, numerous work steps are necessary in assembly, in which individual parts must be joined together, for example by welding.

EP 3 678 208 A1 describes a battery module with several battery cells which are arranged in a horizontal direction, wherein a dimension of the battery module is greater in the horizontal direction than in the vertical direction. The cells of such a battery module can be held together by one or more binding straps.

Furthermore, CN 210723151 U describes a steel strap for enclosing a cell stack with several battery cells, wherein screw sleeves are also arranged on the steel strap, into which sleeves screws can be inserted, by means of which such a battery module can be screwed to a battery housing.

So far, it has not been possible with the battery modules disclosed in the prior art to efficiently provide functions such as the connection to a cooling device, clamping of the battery cells, a high degree of stability, and the provision of support in the z-direction.

### SUMMARY

The object of the present disclosure is therefore to provide a module housing assembly, a battery module, and a method that allow a battery module to be designed as simply and efficiently as possible, and in particular enable a connection to cooling and clamping in the simplest and most efficient manner possible.

This object is achieved by a module housing assembly, a battery module, and a method with the features according to the respective independent claims. Advantageous embodiments of the disclosure are the subject matter of the dependent claims, the description, and the figures.

A module housing assembly according to the disclosure for accommodating at least one battery cell has a module housing, which in turn comprises a housing base, which delimits a receiving area for accommodating the at least one battery cell in a first direction, and two side plates, which delimit the receiving area on both sides in a second direction. In addition, the module housing assembly comprises a retaining element for arrangement on the at least one battery cell accommodated in the receiving area, so that at least a first part of the retaining element delimits the receiving area in the first direction on a side of the receiving area opposite the housing base. In addition, the module housing assembly comprises a clamping device, which extends at least from a first of the side plates to a second of the side plates on a side of the receiving area opposite the housing base, wherein the clamping device is designed in such a way that the clamping device can exert a force onto the retaining element in the direction of the housing base if said retaining element is arranged on the at least one battery cell arranged in the receiving area.

A module housing can therefore be provided which is U-shaped, for example, and in which the at least one battery cell, in particular also several battery cells in the form of a cell stack, can be accommodated. If such at least one battery cell is accommodated in this module housing, the tensioning strap extends at least on the side opposite the housing base and, in doing so, presses the retaining element arranged on the at least one battery cell downwards in the direction of the housing base. Such a clamping device can thus advantageously provide a clamping of such a battery module, on the one hand, and a pressing force in the direction of the housing base can simultaneously be generated by clamping the retaining element between this clamping device and the at least one battery cell. This in turn advantageously allows the housing base to be in the form of a cooling base, for example, or to be connected to a cooling device. In this case, for example, the gap filler mentioned at the outset between the at least one battery cell and the housing base can be dispensed with entirely, since the described pressing force, which can be provided by the combination of the retaining element and the clamping device, efficiently presses the at least one battery cell against the housing base. This makes it possible to provide significantly more efficient heat dissipation. The fact that a module free of gap filler can be provided in this way means that enormous costs and weight can be saved. The manufacturing effort is also reduced enormously as a result. The downward clamping force generated by the clamping device and the retaining element not only enables a good thermal connection to the housing base in an efficient manner, but the retaining element also simultaneously acts as a hold-down device or retaining element in the z-direction, which corresponds to the first direction mentioned above and which preferably extends parallel to the vertical direction of the vehicle, when the module housing assembly is arranged as intended in a motor vehicle. Because the module housing also comprises a housing base that is specifically assigned to the battery module and is arranged directly on the side plates, battery modules can be built much more rigidly, since the two side plates and the housing base form a structural unit, in particular a fixed unit. If the at least one battery cell is accommodated in the receiving area of the module housing assembly, a battery module is provided which, for example, can be used together with other battery modules constructed in this way in an overall battery housing or a frame or a housing trough. The base of such a trough then does not have to be in the form of a cooling base, and it is preferably not in this form either. In addition, the side binders described at the outset, i.e. the side parts, can also be dispensed with. Overall, numerous components can be saved in this way, fewer components have to be joined and assembled in production, and above all the connection to a cooling device can be provided much more efficiently and easily, in particular without the need to provide a gap filler, although it is still possible to provide a gap filler, for example in the form of a curable heat-conducting compound or heat-conducting adhesive, between the at least one battery cell accommodated in the receiving area and the housing base.

The receiving area can be designed in such a way that it is intended to receive only a single battery cell. However, the receiving area is preferably designed in such a way that it can accommodate several battery cells therein, in particular prismatic battery cells. The receiving area can therefore have an essentially cuboid geometry. The several battery cells can be provided in the form of a cell stack and can accordingly be arranged next to one another in a longitudinal extension direction of such a cell stack. This is especially advantageous when the several battery cells are designed, for example, as prismatic battery cells, since this enables an especially compact construction. In addition, the battery cells can be provided as lithium-ion cells, for example. If such a cell stack is accommodated as intended in the receiving area of the module housing assembly, the longitudinal extension direction of the cell stack corresponds to the second direction. Incidentally, the second direction can be oriented perpendicularly to the first direction. The side plates thus function as end plates, which delimit the cell stack in the longitudinal extension direction thereof and via which the cell stack can be clamped, in particular in the second direction. The clamping is also accomplished via the clamping device. The clamping device can be arranged in such a way that it connects at least the two side plates to one another. For example, it can be arranged in such a way that it extends from one side plate to the other side plate and, by means of the clamping force provided by the clamping device, clamps the two side plates together parallel to the second direction. Consequently, a corresponding clamping force can be applied to the cell stack in or opposite the second direction via the side plates, and at the same time a pressing force can be applied, opposite the first direction, to the cells or the cell stack via the retaining element, i.e. in the direction of the housing base. However, the clamping device can also be designed in such a way that it completely encircles the module housing and, for example, also extends on the outside along the housing base in the direction of the second direction. In addition, it is also conceivable that not only one such clamping device is provided per battery module, but also, for example, two or more than two clamping devices extending parallel to one another, which press the same retaining element in the direction of the cell stack and in the direction of the housing base. In addition, it is also conceivable that not only one retaining element is provided, but also several, which can be arranged, for example, extending parallel to one another in the second direction on the at least one battery cell.

In its intended arrangement, a battery cell is preferably arranged in the receiving area in such a way that the terminals thereof are arranged on a side opposite the housing base. The side of the at least one battery cell with the terminals is defined as an upper side of the at least one battery cell in this case. The retaining element is preferably arranged on the upper side of the at least one battery cell when it is located in the receiving area of the module housing assembly. The retaining element can be arranged extending on the terminals or in an area of the upper side of the at least one battery cell between the terminals. The support surface of the retaining element is preferably flat on the side facing the cell stack.

In this case, the retaining element can also extend in a third direction, which is perpendicular to the first and second direction, over the entire width of an upper side of a battery cell or only over part of this upper side in the third direction. The second variant is preferred because it can be implemented in a significantly simpler and more space-efficient manner.

According to a very advantageous embodiment of the disclosure, the housing base is designed as a cooling base. For example, a cooling medium can flow through the housing base. For this purpose, the housing base can be designed with cooling channels through which such a cooling medium can flow. This advantageously allows module cooling to be integrated into a battery module. A complex connection of a battery module to a cooling base of an overall battery housing is therefore no longer necessary.

In a further very advantageous embodiment of the disclosure, the retaining element has a thickness in the first direction which varies along the second direction, in particular which decreases in the direction of the respective side plates starting from a center of the retaining element with respect to the second direction. This can be achieved, for example, in that an upper side of the retaining element facing the clamping device, when this is located on the at least one battery cell arranged in the receiving area, is curved with respect to the second direction, in particular arched and/or monotonically curved. In this way, an especially homogeneous pressing force can be provided in the second direction. This is especially advantageous when several battery cells are accommodated in the receiving area in the form of a cell stack. If the retaining element were instead designed, for example, as a block or cuboid or plate with a constant thickness in the second direction, a higher pressing force in the direction of the housing base would act on those battery cells that are arranged closer to the side plates. This effect can advantageously be compensated precisely by the fact that the retaining element increases in thickness, starting from the side plates in the direction of the center thereof with respect to the second direction. In other words, the thickness of the retaining element is maximum in the center with respect to the second direction. For example, the maximum thickness may be 1 centimeter to 2 centimeters or less than 1 centimeter. In the third direction, however, the thickness of the retaining element preferably does not vary. A uniform pressing force can thus also be provided in the third direction. Optionally, a type of guide groove extending in the second direction can be provided for the clamping device.

In principle, the retaining element can be provided, for example, as a type of block, the thickness of which varies in the longitudinal direction, that is to say in the second direction, for example in the form of an arc-shaped block. However, the side of the retaining element facing the at least one battery cell is preferably of planar design or has a geometry which is adapted, for example is complementary, to a geometry of an upper side of the at least one battery cell. A pressure distribution that is as uniform as possible can thus be provided on the upper side of the at least one battery cell.

Furthermore, it is advantageous if the retaining element extends from the first side plate to the second side plate. If, for example, a cell stack with several battery cells is arranged in the receiving area, then it is preferable for the retaining element to extend over all upper sides of the respective battery cells at the same time. In principle, the retaining element can also be at a certain distance from the side plates, or the retaining element can also have contact with the side plates.

It is also especially advantageous if the retaining element, as is provided according to a further embodiment of the disclosure, has two side tabs which adjoin the first part of the retaining element on both sides in the second direction and extend in the direction of the housing base and which, when the at least one battery cell is accommodated in the receiving area, are each arranged between the at least one battery cell and one of the respective side plates. In other words, these two side tabs can be clamped between the cell stack and the respective side plates. The clamping force with respect to the second direction is additionally achieved by the clamping device. As a result, more stability can be provided with regard to the positioning of the retaining element. Thus, to a certain extent, a movement of the at least one battery cell in the z-direction, i.e. in the first direction, can additionally be prevented by the adhesion generated thereby.

In principle, the retaining element can be made from any desired material, for example plastic, aluminum, wood, or the like. It is especially advantageous if the retaining element comprises a metal and/or a plastic and/or is provided as a hybrid component. Such a hybrid component can comprise both soft components and hard components and, for example, also combine a metallic part with a plastic part or plastic parts of different hardness levels. In addition, it is especially advantageous if the retaining element has an at least partially elastic component, which can be provided simply by a hybrid component, for example. In this case, a damping effect can be provided by such an at least partially elastic component. In this way, external forces acting on the battery module can be especially gently damped.

In a further advantageous embodiment of the disclosure, the clamping device is designed as at least one tensioning strap. Such a tensioning strap can be tensioned around the module housing with the cell stack accommodated in the receiving area in an especially simple manner. In addition, such a tensioning strap can also be provided in a simple and cost-effective manner. For example, it can be provided as tape, for example. There are also different options for the material. For example, the at least one tensioning strap can have a fiber-reinforced plastic, for example made of a glass-fiber-reinforced plastic or carbon-fiber-reinforced plastic, and/or a carbon-fiber strap or be designed as such, and/or a metal or be designed as a metal strap, such as a steel strap, aluminum strap, and so on. It is especially advantageous if the tensioning strap comprises a carbon-fiber strap or is designed as such. This offers a high degree of stability and flexibility at the same time. This is also especially advantageous when combined with a plastic housing, as will be explained in more detail later. However, a high degree of stability can also be provided by a metal strap. In addition, metal has the advantage that it is heat-resistant and can easily withstand the high clamping forces.

In a further advantageous embodiment of the disclosure, the module housing is formed at least for the most part from a plastic, in particular a fiber-reinforced plastic, and/or comprises a metal or an alloy. It is especially advantageous, above all, if the housing is provided as a plastic housing, for example made of a fiber-reinforced plastic, and is in particular designed in one piece. In other words, the housing base and the side plates can be manufactured as a plastic component, for example by means of an injection-molding process. Nevertheless, the housing base and side plates may also be provided as separate plastic components that are bonded together, e.g. welded together, as a strap assembly. The formation of the side plates in particular from plastic also enables an especially advantageous attachment of the tensioning strap, in particular if it is also made of plastic or is provided as a carbon strap. It is particularly advantageous if the tensioning strap also has two strap ends which are attached to at least one of the side plates, in particular into which at least one of the side plates, which is largely made of a plastic, is partially cast. For example, a groove extending in the third direction can be provided on one of the side plates, in which one or two eyelets are also provided for passing through the two tensioning strap ends, in order to clamp the tensioning strap after the at least one battery cell has been accommodated in the receiving area. In the tensioned state, the eyelets can then be filled with plastic in an injection-molding process, for example, whereby the tensioning strap ends are finally attached to the one side plate. This establishes an especially stable connection between the tensioning strap and the side plate. This also enables an especially simple clamping. For example, if the eyelets are oriented at an angle to the direction of rotation of the strap, for example of 45 degrees, it is possible to clamp the tensioning strap by tensioning the ends in and opposite the third direction, i.e. perpendicular to the first direction. Alternatively, the tensioning strap ends could also be fastened to one another in an overlapping manner. A form-fitting or material-fitting attachment to the side plate is then not required. However, the clamping of the tensioning strap is somewhat more difficult here than in the previously described variant.

If the module housing is made of a metal or an alloy, for example aluminum, it can also be provided that another fastening mechanism, for example rivets or welding or the like, is used to fasten the tensioning strap to the side plate.

In a further advantageous embodiment of the disclosure, the clamping device and/or the retaining element has at least one releasable passage opening assigned to a releasable degassing opening of the at least one battery cell, which passage opening is arranged in the first direction above the degassing opening of the at least one battery cell, in particular when the at least one battery cell is accommodated in the receiving area. Battery cells typically have releasable degassing openings, for example in the form of a bursting membrane, which is often arranged on the upper side of such a battery cell between the terminals. Such a releasable degassing opening makes it possible for gases emerging from the battery cell to be discharged from the battery cell in a targeted manner in an emergency, for example in case of a thermal event, without the battery cell exploding in the process.

Precisely when the retaining element is arranged on these degassing openings above the battery cells, it is advantageous if such an at least releasable degassing opening or passage opening is also provided in the retaining element and/or in the overlying tensioning strap. Specifically a tensioning strap can also provide such a releasable degassing opening, for example, simply as a type of predetermined breaking point, for example as a material weakening, perforation, or the like, which ruptures as soon as gas escapes from the at least one battery cell. Optionally, gas-routing channels integrated into the retaining element can also be provided to direct the gas flow that escapes from the battery cells. Gas escaping from the battery cells can be routed out of the battery module and in particular out of the entire battery through the battery gas-routing channels, for example in or opposite the second direction and/or in or opposite the third direction.

Furthermore, the disclosure also relates to a battery module with a battery module assembly according to the disclosure or one of the embodiments thereof. The advantages described for the module housing assembly according to the disclosure apply in the same way to the battery module according to the disclosure. In addition to the module housing assembly, the battery module can also have at least one battery cell accommodated in the receiving area. The battery module preferably comprises a cell stack with several battery cells arranged next to one another in the second direction and arranged in the receiving area. These can be designed as described above.

A motor vehicle with a module housing assembly according to the disclosure or a battery module according to the disclosure or one of the embodiments thereof should also be regarded as part of the disclosure.

If such a battery module is installed in the motor vehicle, then the first direction preferably corresponds to the vertical direction of the vehicle. The second direction and the third direction can then correspond, for example, to the longitudinal direction of the vehicle and to the transverse direction of the vehicle, or vice versa.

The disclosure also relates to a method for clamping a battery module, which has a module housing assembly that comprises a module housing with a housing base, which delimits a receiving area for accommodating at least one battery cell in a first direction, and two side plates, which delimit the receiving area on both sides in a second direction. A retaining element is arranged on the at least one battery cell, so that when the at least one battery cell is arranged in the receiving area, at least a first part of the retaining element delimits the receiving area in the first direction on a side of the receiving area opposite the housing base. In addition, a clamping device is provided, which extends at least from a first of the side plates to a second of the side plates on a side of the receiving area opposite the housing base, and which is clamped in such a way that a force is applied to the retaining element in the direction of the housing base by means of the clamping device, if the retaining element is arranged on the at least one battery cell arranged in the receiving area.

The advantages described for the module housing assembly according to the disclosure and the embodiments thereof also apply in the same manner to the method according to the disclosure.

The disclosure also comprises refinements of the method according to the disclosure, which have features as already described in the context of the refinements of the module housing assembly according to the disclosure. For this reason, the corresponding refinements of the method according to the disclosure are not described again here.

The motor vehicle according to the disclosure is preferably designed as an automobile, in particular as a passenger car or truck, or as a passenger bus or motorcycle.

The disclosure also comprises combinations of the features of the described embodiments. The disclosure thus also comprises implementations that each have a combination of the features of several of the described embodiments, provided that the embodiments were not described as being mutually exclusive.

### BRIEF DESCRIPTION OF THE DRAWINGS

Exemplary embodiments of the disclosure are described hereinafter. The following is shown:

FIG. 1 a schematic exploded view of a battery module according to an example which is not part of the disclosure;

FIG. 2 a schematic view of a battery module with a battery module housing assembly according to an exemplary embodiment of the disclosure;

FIG. 3 a schematic and perspective view of a part of the module housing assembly according to an exemplary embodiment of the disclosure;

FIG. 4 a schematic representation of a plan view of a part of a tensioning strap with a releasable degassing opening according to an exemplary embodiment of the disclosure;

FIG. 5 a schematic representation of a part of a tensioning strap with a releasable degassing opening according to a further exemplary embodiment of the disclosure;

FIG. 6 a schematic representation of a part of a battery module in three different degassing states according to an exemplary embodiment of the disclosure.

### DETAILED DESCRIPTION

The exemplary embodiments explained hereinafter are preferred embodiments of the disclosure. In the exemplary embodiments, the described components of the embodiments each represent individual features of the disclosure to be considered independently of one another, which each also refine the disclosure independently of one another. Therefore, the disclosure is also intended to comprise combinations of the features of the embodiments other than those shown. Furthermore, the described embodiments can also be supplemented by further ones of the above-described features of the disclosure.

In the figures, the same reference signs designate elements that have the same function.

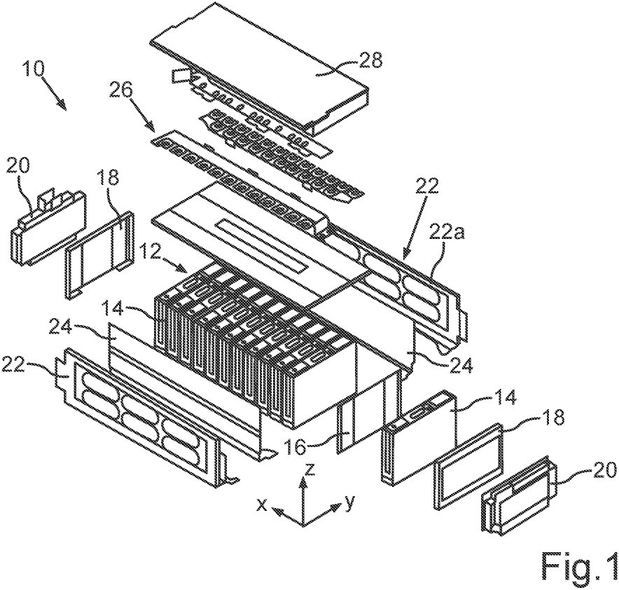

FIG. 1shows a schematic exploded view of a battery module 10 according to an example which is not part of the disclosure. In this case, the battery module has a cell stack 12 with several battery cells 14, of which only one is provided with a reference numeral for reasons of clarity. The battery cells 14 can be separated from one another by separating elements for electrical and/or thermal decoupling. Such a cell stack 12 is also delimited on both sides by respective end plates 18, into which further components 20, such as electronic components, can be integrated externally. In order to clamp the battery cells 14 together in the x-direction, the end plates 16 are connected to one another and clamped via side binders 22. Insulation inserts 24 can be introduced between the side binders 22 and the cell stack 12. The side binders 22 usually have a chamfer 22a on the upper edge so that the cells 14 do not fall out of the module 10 when subjected to loads in the z-direction. Further components can then be placed on the module, such as electrical interconnection components 26 and a module cover 28. Overall, such a module 10 is therefore composed of numerous different parts. This has clear disadvantages, especially with regard to preloading of the cells, because the forces cannot be optimally dissipated and the structures are not as stiff as a highly integrated structure, for example. In addition, numerous work steps are necessary in assembly, in which individual parts must be joined together.

These disadvantages can now be advantageously avoided by the disclosure or the embodiments thereof.

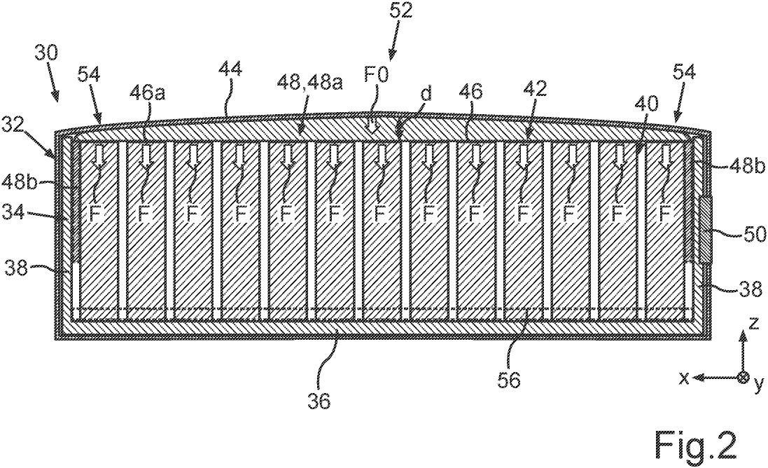

FIG. 2 shows schematic view of a battery module 30 with a module housing assembly 32 according to an exemplary embodiment of the disclosure. The module housing assembly 32 in this case is preferably in the form of a fully integrated plastic module, although it is also conceivable to use metal housing components. Basically, this module housing assembly 32 initially comprises a module housing 34 which in turn comprises a housing base 36 and two side plates 38. The module housing 34 has a receiving area 40 in which, in this example, a cell stack 42 with several battery cells 46 arranged next to one another in the x-direction is accommodated. The side plates 38 delimit the receiving area 40 in the x-direction, while the housing base 36 is arranged on the lower side of the receiving area 40 and thus delimits the receiving area 40 downwards, i.e. opposite the shown z-direction. The housing 34 can be designed to be open in the y-direction.The side plates 38 are preferably aligned perpendicularly to the housing base 36 and are attached thereto. Optionally, these side plates can also be designed in one piece with the base. Since the pressure plates provided by the side plates 38 and the base plate, i.e. the housing base 36, are a fixed unit and there are no welded joints, the modules 30 can be built significantly more rigidly. In addition, fewer parts have to be joined and assembled in production. A design made of a plastic or a plastic composite material, for example a fiber-reinforced plastic, also has the great advantage that no additional insulation elements and inserts have to be provided between the cell stack 42 and the housing components 36, 38. The housing base 36 is also preferably designed as a cooling base, that is to say it can have cooling channels through which a coolant can flow, which are not shown here, however. The cell cooling can thus be integrated directly into the module 30. To clamp the battery cells 46 in the x-direction and at the same time to press the battery cells 46 opposite the z-direction, the module housing assembly 32 also has a clamping device in the form of a tensioning strap 44 and a retaining element 48. The retaining element 48 or at least a part 48a thereof is arranged on the cell stack 42 on a side opposite the housing base 36. Optionally, this retaining element 48 can also have two second parts 48b, which can be provided in the form of tabs 48b, which are arranged or clamped between the side plates 38 and the cell stack 42. Thus, the retaining element 48 is optionally inserted into the lateral pressure plates 38, i.e. the side plates 38, or between the side plates 38 and the cell stack 42. However, the retaining element 48 can also consist solely of the aforementioned first part 48a. The tensioning strap 44 completely surrounds the module housing assembly 32 with the cell stack 42 accommodated therein and can, for example, be fastened to one of the side plates 38 in a fastening region 50. The side plates 38 in this case can also be provided with a small groove that extends in the y-direction and through which the tensioning strap 44, which is preferably designed as a tape, is pulled so that it can be tightened during assembly to clamp the tensioning strap 44. After the tensioning strap has been clamped, this groove can be filled with injection molding, for example, in order to attach the tape 44 to the side plate 38. This creates a kind of wedge effect.

Since this tape 44 extends above the battery cells 46 in combination with the retaining element 48, the cells 46 can be prevented from lifting off in the z-direction. However, it is especially advantageous that this tensioning strap 44, in combination with the retaining element 48, which provides a hold-down device, can also be used to exert a pressing force downwards on the battery cells 46, opposite the z-direction, in the direction of the housing base 36. This pressing force on the respective cells 46 is denoted by F in the present case. This results from an initial force F0,which is exerted on the hold-down devices 48 via the tensioning strap 44. Furthermore, the retaining element 48 has a thickness d in the z-direction, which varies in the x-direction. In particular, the retaining element 48 is thicker in the center 52 thereof with respect to the x-direction than in the edge region 54 near the side plates 38. The retaining element 48 therefore has a different wall thickness on the outside 54 than in the center 52 of the component 48. This makes it possible for the pressing forces F to be distributed almost homogeneously on the cells 46 over the entire x-direction. These can thus advantageously be pressed evenly against the cooling base 36. As a result of these pressing forces F, a gap filler between the cells 46 and the cooling base 36 can also be dispensed with. This allows a significantly more efficient connection to the cooling base 36. Since a base 36 is integrated into the module 30, which base serves as a cooling base 36 at the same time, advantageously no further effort is required for gap fillers or bases integrated into the battery housing. In addition, crash structures 56 can also be easily integrated into the base 36, which can be accomplished especially easily if the base 36 or the housing 34 is made of plastic. In the present example, these crash structures 56 are shown only schematically with dashed lines. These structures can be provided, for example, as a kind of edge or protruding elevation relative to the base plane of the housing base 36.

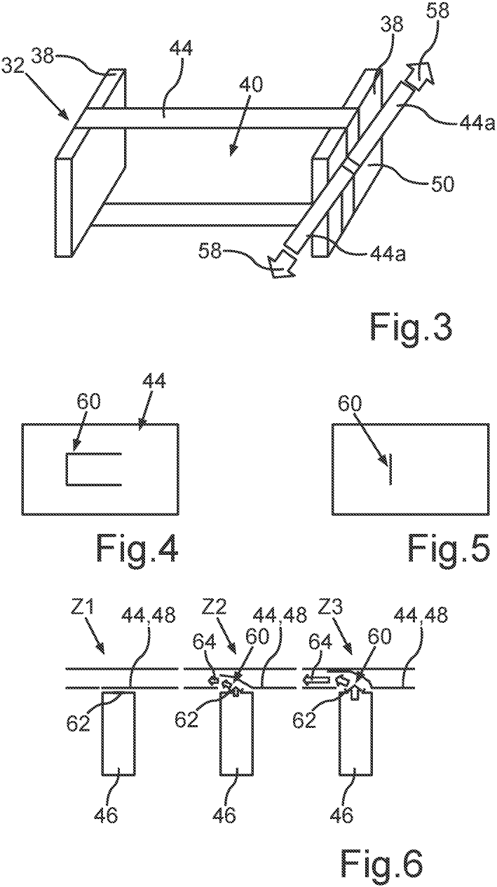

FIG. 3 again shows a schematic representation of a part of the module housing assembly 32, in particular without the hold-down device 48 and the housing base 36, and without the cells 46 accommodated in the receiving area 40. In particular, the two side plates 38 are shown here with the tensioning strap 44, in particular to illustrate the clamping process. The ends 44a of the tensioning strap 44 can be passed through eyelets on one of the side plates 38 in a fastening region 50, which eyelets form, for example, a 45 degree angle with the x- and z-direction. This allows clamping of the tensioning strap 44 by pulling 58 on the ends 44a in the y-directionas shown. The tightening is indicated by the arrows 58. If the tensioning strap 44 is sufficiently clamped, the eyelet area in the fastening region 50 can be filled with plastic and the tensioning strap 44 can thus be cast in the fastening region with the side plate 38.

The pressure F on the cells 46 can be set opposite the z-direction by means of the tensioning force of the tensioning strap 44 in combination with the variable thickness d of the retaining element 48. The retaining element 48 coupled to the tensioning strap 44 thus advantageously allows an additional compressive force from the tensile force of the strap 44 to be applied to the cells 46.

If the tape 44 extends between the terminals of the battery cells 46, which can be arranged on the respective upper sides 46a of the battery cells 46 (see FIG. 2), it is preferred that the tape 44 has openings or at least fully or partially stamped or cut or cut-through areas to provide releasable openings. These are shown as examples in FIGS. 4 and 5 in a plan view of the tape 44. Such a releasable opening 60 is formed by a U-shaped cut, through-cut, stamping, or perforation in the tensioning strap 44 in FIG. 4, and it is formed as a straight cut or through-cut or perforation or stamping in FIG. 5. If gas emerges from the battery cells 46, these openings 60 open at the predetermined breaking points provided in this way, as a result of which the gas can escape. This is shown schematically in FIG. 6 in a side view for three different degassing states. The different states are denoted by Z1,Z2, and Z3. A battery cell 46 is shown in particular as well as the overlying combination of retaining element 48 and tape 44 for a respective state Z1,Z2, Z3. The first state Z1 shows the cell 46 in the normal operating state, in which no outgassing takes place. A releasable degassing opening 62 assigned to the upper side of the cell 46 is closed here, as is the releasable degassing opening 60 of the tape 44. In the second state Z2, the cell 46 begins to degas and puts pressure onto the bursting element 60 of the cell 46. This allows gas 64 to escape from the cell 46. In state Z3, the cell 46 degasses even more and the gas flow 64 is guided in a targeted manner through the torn strap section of the tape 44, which can come into contact with or be supported on, for example, an overlying plate, for example a housing cover. Optionally, a gas-routing channel can also be integrated into the hold-down device 48 or passage openings arranged extending in the z-direction over the bursting membranes 60 of the cells 46.

Overall, the examples show how the disclosure can provide a retaining element in the z-direction, which allows efficient formation of a battery module with a retaining element, which in turn contains or provides a homogeneous load distribution due to the deformation or geometry of the retaining element. The entire module can be made of plastic and designed to be highly integrated. Such a module can be significantly lighter, since tapes acting as a tensioning strap are very light. Overall, a cost saving of 10 to 15 percent can be achieved. Above all, the provision of a significantly simpler module housing without costly cooling is made possible as well as a module completely free of gap filler.

1. A module housing assembly for accommodating at least one battery cell, wherein the module housing assembly comprises:
a module housing with a housing base, which delimits a receiving area for accommodating the at least one battery cell with respect to a first direction, and two side plates, which delimit the receiving area on both sides with respect to a second direction;
wherein the module housing assembly includes;
a retaining element for arrangement on the at least one battery cell accommodated in the receiving area, so that at least a first part of the retaining element delimits the receiving area with respect to the first direction on a side of the receiving area opposite the housing base; and
a clamping device, which extends at least from a first of the side plates to a second of the side plates on a side of the receiving area opposite the housing base, wherein the clamping device is designed in such a way that the clamping device can exert a force on the retaining element in a direction of the housing base, if said retaining element is arranged on the at least one battery cell arranged in the receiving area.

2. The Module housing assembly according to claim 1, wherein the housing base is designed as a cooling base.

3. The Module housing assembly according to claim 1, wherein the retaining element has a thickness with respect to the first direction which varies along the second direction, in particular which decreases in the direction of the respective side plates starting from a center of the retaining element with respect to the second direction.

4. The Module housing assembly according to claim 1, wherein the retaining element has two side tabs which adjoin the first part of the retaining element on both sides in the second direction and extend in the direction of the housing base and which, when the at least one battery cell is accommodated in the receiving area, are each arranged between the at least one battery cell and one of the respective side plates.

5. The Module housing assembly according to claim 1, wherein the retaining element comprises a metal and/or a plastic and/or is provided as a hybrid component which in particular has an at least partially elastic component.

6. The Module housing assembly according to claim 1, wherein the clamping device is designed as at least one tensioning strap, in particular wherein the at least one tensioning strap
has a fiber composite plastic; and/or
has a carbon-fiber strap or is designed as such; and/or
has a metal or is designed as a metal strap.

7. The Module housing assembly according to claim 1, wherein the module housing is mostly formed from a plastic, in particular a fiber-reinforced plastic, and/or comprises a metal or an alloy.

8. The Module housing assembly according to claim 1, wherein the clamping device and/or the retaining element has at least one releasable passage opening assigned to a releasable degassing opening of the at least one battery cell, which passage opening is arranged in the first direction above the degassing opening of the at least one battery cell, in particular when the at least one battery cell is accommodated in the receiving area.

9. A Battery module with a module housing assembly according to claim 1 and at least one battery cell accommodated in the receiving area.

10. A Method for clamping a battery module, which has a module housing assembly that comprises a module housing with a housing base, which delimits a receiving area for accommodating at least one battery cell in a first direction, and two side plates, which delimit the receiving area on both sides in a second direction, wherein that a retaining element is arranged on the at least one battery cell, so that, when the at least one battery cell is arranged in the receiving area, at least a first part of the retaining element delimits the receiving area in the first direction on a side of the receiving area opposite the housing base, and a clamping device is provided, which extends at least from a first of the side plates to a second of the side plates on a side of the receiving area opposite the housing base, and which is clamped in such a way that the clamping device exerts a force on the retaining element in a direction of the housing base, if said retaining element is arranged on the at least one battery cell arranged in the receiving area.

11. The Module housing assembly according to claim 2, wherein the retaining element has a thickness with respect to the first direction which varies along the second direction, in particular which decreases in the direction of the respective side plates starting from a center of the retaining element with respect to the second direction.

12. The Module housing assembly according to claim 2, wherein the retaining element has two side tabs which adjoin the first part of the retaining element on both sides in the second direction and extend in the direction of the housing base and which, when the at least one battery cell is accommodated in the receiving area, are each arranged between the at least one battery cell and one of the respective side plates.

13. The Module housing assembly according to claim 3, wherein the retaining element has two side tabs which adjoin the first part of the retaining element on both sides in the second direction and extend in the direction of the housing base and which, when the at least one battery cell is accommodated in the receiving area, are each arranged between the at least one battery cell and one of the respective side plates.

14. The Module housing assembly according to claim 2, wherein the retaining element comprises a metal and/or a plastic and/or is provided as a hybrid component which in particular has an at least partially elastic component.

15. The Module housing assembly according to claim 3, wherein the retaining element has a thickness with respect to the first direction which varies along the second direction, in particular which decreases in the direction of the respective side plates starting from a center of the retaining element with respect to the second direction.

16. The Module housing assembly according to claim 4, wherein the retaining element comprises a metal and/or a plastic and/or is provided as a hybrid component which in particular has an at least partially elastic component.

17. The Module housing assembly according to claim 2, wherein the clamping device is designed as at least one tensioning strap, in particular wherein the at least one tensioning strap
has a fiber composite plastic; and/or
has a carbon-fiber strap or is designed as such; and/or
has a metal or is designed as a metal strap.

18. The Module housing assembly according to claim 3, wherein the clamping device is designed as at least one tensioning strap, in particular wherein the at least one tensioning strap
has a fiber composite plastic; and/or has a carbon-fiber strap or is designed as such; and/or
has a metal or is designed as a metal strap.

19. The Module housing assembly according to claim 4, wherein the clamping device is designed as at least one tensioning strap, in particular wherein the at least one tensioning strap
has a fiber composite plastic; and/or
has a carbon-fiber strap or is designed as such; and/or
has a metal or is designed as a metal strap.

20. The Module housing assembly according to claim 5, wherein the clamping device is designed as at least one tensioning strap, in particular wherein the at least one tensioning strap
has a fiber composite plastic; and/or
has a carbon-fiber strap or is designed as such; and/or
has a metal or is designed as a metal strap.
